(19) United States
(12) Patent Application Publication
(10) Pub. No.: US 2025/0136852 A1
(43) Pub. Date: May 1, 2025

(54) PRESSURE SENSITIVE ADHESIVE

(71) Applicant: SAINT-GOBAIN PERFORMANCE PLASTICS CORPORATION, Solon, OH (US)

(72) Inventors: Hongbo FU, Shrewsbury, MA (US); Jeffrey H. Peet, Southborough, MA (US)

(21) Appl. No.: 18/925,733

(22) Filed: Oct. 24, 2024

Related U.S. Application Data
(60) Provisional application No. 63/593,823, filed on Oct. 27, 2023.

(51) Int. Cl. C09J 109/00; C08K 5/14; C09J 7/38

(52) U.S. Cl. CPC C09J 109/00; C08K 5/14; C09J 7/381; C09J 2301/122; C09J 2301/302; C09J 2301/414; C09J 2409/00; C09J 2467/006; C09J 2479/086

(57) ABSTRACT

The present disclosure relates to a pressure sensitive adhesive may include a polyisobutylene-based material, and a peroxide based additive. The pressure sensitive adhesive may have an Adhesive Electrolyte Exposure Peel Force (AEEPF) of at least about 0.5 N/cm.

### CROSS-REFERENCE TO RELATED APPLICATION(S)

This Application claims priority under 35 U.S.C. § 119(e) to U.S. Provisional Patent Application No. 63/593,823, entitled “PRESSURE SENSITIVE ADHESIVE,” by Hongbo F U et al., filed Oct. 27, 2023, which is assigned to the current assignee hereof and is incorporated herein by reference in its entirety.

### FIELD OF THE DISCLOSURE

The present disclosure relates to a pressure sensitive adhesive, in particular, a polyisobutylene-based pressure sensitive adhesive.

### BACKGROUND

Pressure sensitive adhesives are used in various applications, including applications in the presence of solvents that can degrade the adhesive. For example, pressure sensitive adhesives may be used in the presence of polar aprotic solvents like those found in certain battery electrolyte systems and oil filled transformers. Accordingly, pressure sensitive adhesives that provide high peel strength and high polar solvent resistance are desired.

### SUMMARY

According to a first aspect, a pressure sensitive adhesive may include a polyisobutylene-based material, and a peroxide based additive. The pressure sensitive adhesive may have an Adhesive Electrolyte Exposure Peel Force (AEEPF) of at least about 0.5 N/cm.

According to another aspect, a pressure sensitive adhesive may include a polyisobutylene-based material, and a peroxide based additive. The pressure sensitive adhesive may have an Adhesive Electrolyte Peel Force Retention (AEEPF-R) of at least about 0.4, where the AEEPF-R is equal to Adhesive Electrolyte Exposure Peel Force (AEEPF) of the pressure sensitive adhesive divided by the Adhesive Original Peel Force (AOPF) of the pressure sensitive adhesive.

According to still another aspect, an adhesive tape may include a backing material and a pressure sensitive adhesive applied over a first surface of the backing material. The pressure sensitive adhesive may include a polyisobutylene-based material, and a peroxide based additive. The adhesive tape may have a Tape Electrolyte Exposure Peel Force (TEEPF) of at least about 0.5 N/cm.

According to still another aspect, an adhesive tape may include a backing material and a pressure sensitive adhesive applied over a first surface of the backing material. The pressure sensitive adhesive may include a polyisobutylene-based material, and a peroxide based additive. The adhesive tape may have a Tape Electrolyte Peel Force Retention (TEEPF-R) of at least about 0.4, where the TEEPF-R is equal to Tape Electrolyte Exposure Peel Force (TEEPF) of the adhesive tape divided by the Tape Original Peel Force (TOPF) of the adhesive tape.

According to yet another aspect, a method of forming a pressure sensitive adhesive may include providing a precursor mixture of a polyisobutylene-based material, and a peroxide based additive, and curing the precursor mixture to form a pressure sensitive adhesive. The pressure sensitive adhesive may have an Adhesive Electrolyte Exposure Peel Force (AEEPF) of at least about 0.5 N/cm.

According to still another aspect, a method of forming a pressure sensitive adhesive may include providing a precursor mixture of a polyisobutylene-based material, and a peroxide based additive, and curing the precursor mixture to form a pressure sensitive adhesive. The pressure sensitive adhesive may have an Adhesive Electrolyte Peel Force Retention (AEEPF-R) of at least about 0.4, where the AEEPF-R is equal to Adhesive Electrolyte Exposure Peel Force (AEEPF) of the pressure sensitive adhesive divided by the Adhesive Original Peel Force (AOPF) of the pressure sensitive adhesive.

According to still another aspect, a method of forming an adhesive tape may include providing a precursor mixture of a polyisobutylene-based material and a peroxide based additive, applying the precursor mixture on a first side of a backing material, and curing the precursor mixture to form a pressure sensitive adhesive on the first side of the backing material. The pressure sensitive adhesive may include a polyisobutylene-based material, and a peroxide based additive. The adhesive tape may have a Tape Electrolyte Exposure Peel Force (TEEPF) of at least about 0.5 N/cm.

According to still another aspect, a method of forming an adhesive tape may include providing a precursor mixture of a polyisobutylene-based material and a peroxide based additive, applying the precursor mixture on a first side of a backing material, and curing the precursor mixture to form a pressure sensitive adhesive on the first side of the backing material. The adhesive tape may have a Tape Electrolyte Peel Force Retention (TEEPF-R) of at least about 0.4, where the TEEPF-R is equal to Tape Electrolyte Exposure Peel Force (TEEPF) of the adhesive tape divided by the Tape Original Peel Force (TOPF) of the adhesive tape.

### BRIEF DESCRIPTION OF THE DRAWINGS

Embodiments are illustrated by way of example and are not limited to the accompanying figures.

FIG. 1 includes a diagram showing a pressure sensitive adhesive forming method according to embodiments described herein;

FIG. 2 includes an illustration showing the configuration of a layer of pressure sensitive adhesive formed according to embodiments described herein;

FIG. 3 includes a diagram showing a tape forming method according to embodiments described herein; and

FIG. 4 includes an illustration showing the configuration of a tape formed according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a pressure sensitive adhesive that may include a polyisobutylene-based material, and a peroxide based additive.

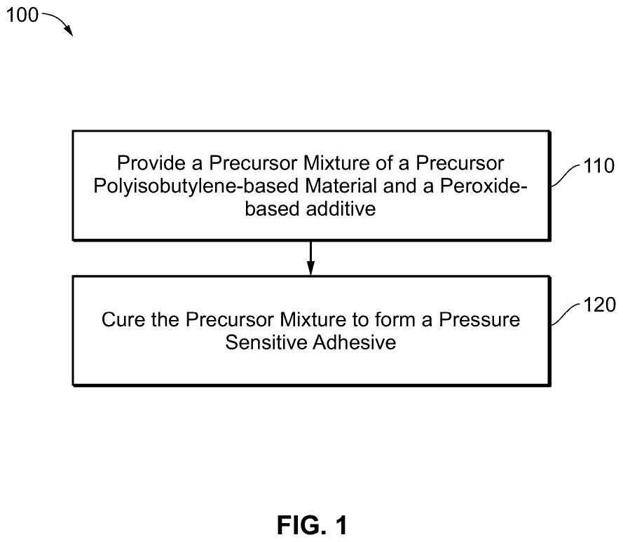

Referring first to a method of forming a pressure sensitive adhesive, FIG. 1 includes a diagram showing a forming method 100 for forming a pressure sensitive adhesive according to embodiments described herein. According to particular embodiments, the forming method 100 may include a first step 110 of providing a precursor mixture of a precursor polyisobutylene-based material, and a peroxide-based additive, and a second step 120 of curing the precursor mixture to form a pressure sensitive adhesive.

According to particular embodiments, the precursor mixture may include a particular content of the precursor polyisobutylene-based material. For example, the precursor mixture may include a precursor polyisobutylene-based material content of at least about 40.00 wt. % for a total weight of the precursor mixture, such as, at least about 45.00 wt. % or at least about 50.00 wt. % or at least about 55.00 wt. % or at least about 60.00 wt. % or at least about 65.00 wt. % or at least about 70.00 wt. % or at least about 75.00 wt. % or at least about 80.00 wt. % or at least about 85.00 wt. % or at least about 90.00 wt. % or at least about 91.00 wt. % or at least about 92.00 wt. % or at least about 93.00 wt. % or at least about 94.00 wt. % or at least about 95.00 wt. % or at least about 96.00 wt. % or at least about 97.00 wt. %. According to still other embodiments, the precursor mixture may include a precursor polyisobutylene-based material content of not greater than about 99.75 wt. % for a total weight of the precursor mixture, such as, not greater than about 99.50 wt. % or not greater than about 99.25 wt. % or not greater than about 99.00 wt. % or not greater than about 98.75 wt. % or not greater than about 98.50 wt. % or not greater than about 97.00 wt. % or not greater than about 96.50 wt. % or even not greater than about 96.00 wt. %. It will be appreciated that the precursor mixture may include a precursor polyisobutylene-based material content of any value between, and including, any of the minimum and maximum values noted above. It will be further appreciated that the precursor mixture may include a precursor polyisobutylene-based material content within a range between, and including, any of the minimum and maximum values noted above.

According to particular embodiments, the precursor mixture may include a particular content of the precursor peroxide based additive. For example, the precursor mixture may include a precursor peroxide based additive content of at least about 0.25 wt. % for a total weight of the precursor mixture, such as, at least about 0.30 wt. % or at least about 0.35 wt. % or at least about 0.40 wt. % or at least about 0.45 wt. % or at least about 0.50 wt. % or at least about 0.60 wt. % or at least about 0.70 wt. % or at least about 0.80 wt. % or at least about 0.90 wt. % or even at least about 1.00 wt. %. According to still other embodiments, the precursor mixture may include a precursor peroxide based additive content of not greater than about 5.00 wt. % for a total weight of the precursor mixture, such as, not greater than about 4.75 wt. % or not greater than about 4.50 wt. % or not greater than about 4.25 wt. % or not greater than about 4.00 wt. % or not greater than about 3.50 wt. % or not greater than about 3.00 wt. % or even not greater than about 2.00 wt. %. It will be appreciated that the precursor mixture may include a precursor polyisobutylene-based material content of any value between, and including, any of the minimum and maximum values noted above. It will be further appreciated that the precursor mixture may include a precursor polyisobutylene-based material content within a range between, and including, any of the minimum and maximum values noted above.

According to particular embodiments, the precursor mixture may include a precursor tackifying resin. According to yet other embodiments, the precursor mixture may include a particular content of the precursor tackifying resin. For example, the precursor mixture may include a precursor tackifying resin content of at least about 0.1 wt. % for a total weight of the precursor mixture, such as, at least about 0.5 wt. % or at least about 1.00 wt. % or at least about 2.00 wt. % or at least about 3.00 wt. % or at least about 4.00 wt. % or at least about 5.00 wt. % or at least about 6.00 wt. % or at least about 7.00 wt. % or at least about 8.00 wt. % or at least about 9.0 wt. % or even at least about 10.00 wt. %. According to still other embodiments, the precursor mixture may include a precursor tackifying resin content of not greater than about 30.00 wt. % for a total weight of the precursor mixture, such as, not greater than about 29.00 wt. % or not greater than about 28.00 wt. % or not greater than about 27.00 wt. % or not greater than about 26.00 wt. % or not greater than about 25.00 wt. % or not greater than about 24.00 wt. % or not greater than about 23.00 wt. % or not greater than about 22.00 wt. % or not greater than about 21.00 wt. % or even not greater than about 20.00 wt. %. It will be appreciated that the precursor mixture may include a precursor polyisobutylene-based material content of any value between, and including, any of the minimum and maximum values noted above. It will be further appreciated that the precursor mixture may include a precursor polyisobutylene-based material content within a range between, and including, any of the minimum and maximum values noted above.

According to particular embodiments, the precursor polyisobutylene-based material may include a particular content of polyisobutylene. For example, the precursor polyisobutylene-based material may include a polyisobutylene content of at least about 40.00 wt. % for a total weight of the precursor mixture, such as, at least about 45.00 wt. % or at least about 50.00 wt. % or at least about 55.00 wt. % or at least about 60.00 wt. % or at least about 65.00 wt. % or at least about 70.00 wt. % or at least about 75.00 wt. % or at least about 80.00 wt. % or at least about 85.00 wt. % or at least about 90.00 wt. % or at least about 91.00 wt. % or at least about 92.00 wt. % or at least about 93.00 wt. % or at least about 94.00 wt. % or at least about 95.00 wt. % or at least about 96.00 wt. % or at least about 97.00 wt. %. According to still other embodiments, the precursor polyisobutylene-based material may include a polyisobutylene content of not greater than about 99.75 wt. % for a total weight of the precursor polyisobutylene-based material, such as, not greater than about 99.50 wt. % or not greater than about 99.25 wt. % or not greater than about 99.00 wt. % or not greater than about 98.75 wt. % or not greater than about 98.50 wt. % or not greater than about 97.00 wt. % or not greater than about 96.50 wt. % or even not greater than about 96.00 wt. %. It will be appreciated that the precursor polyisobutylene-based material may include a polyisobutylene content of any value between, and including, any of the minimum and maximum values noted above. It will be further appreciated that the precursor polyisobutylene-based material may include a polyisobutylene content within a range between, and including, any of the minimum and maximum values noted above.

According to yet other embodiments, the precursor polyisobutylene-based material may consist of polyisobutylene. According to still other embodiments, the precursor polyisobutylene-based material may be polyisobutylene.

According to yet other embodiments, the precursor peroxide based additive may consist of a peroxide material. According to still other embodiments, the precursor peroxide based additive may be peroxide material.

According to still other embodiments, the peroxide material may be a particular peroxide material. For example, the peroxide material may include benzyl peroxide. According to still other embodiments, the peroxide material may consist of benzyl peroxide. According to yet other embodiments, the peroxide material may be benzyl peroxide.

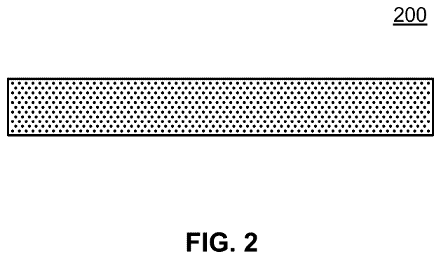

Referring now to embodiments of the pressure sensitive adhesive formed according to forming method 100, FIG. 2 includes diagram of a layer of pressure sensitive adhesive 200. As shown in FIG. 2, the pressure sensitive adhesive 200 may include a polyisobutylene-based material, and a peroxide based additive.

According to particular embodiments, the pressure sensitive adhesive 200 may include a particular content of the polyisobutylene-based material. For example, the pressure sensitive adhesive 200 may include a polyisobutylene-based material content of at least about 40.00 wt. % for a total weight of the pressure sensitive adhesive 200, such as, at least about 45.00 wt. % or at least about 50.00 wt. % or at least about 55.00 wt. % or at least about 60.00 wt. % or at least about 65.00 wt. % or at least about 70.00 wt. % or at least about 75.00 wt. % or at least about 80.00 wt. % or at least about 85.00 wt. % or at least about 90.00 wt. % or at least about 91.00 wt. % or at least about 92.00 wt. % or at least about 93.00 wt. % or at least about 94.00 wt. % or at least about 95.00 wt. % or at least about 96.00 wt. % or at least about 97.00 wt. %. According to still other embodiments, the pressure sensitive adhesive 200 may include a polyisobutylene-based material content of not greater than about 99.75 wt. % for a total weight of the pressure sensitive adhesive 200, such as, not greater than about 99.50 wt. % or not greater than about 99.25 wt. % or not greater than about 99.00 wt. % or not greater than about 98.75 wt. % or not greater than about 98.50 wt. % or not greater than about 97.00 wt. % or not greater than about 96.50 wt. % or even not greater than about 96.00 wt. %. It will be appreciated that the pressure sensitive adhesive 200 may include a polyisobutylene-based material content of any value between, and including, any of the minimum and maximum values noted above. It will be further appreciated that the pressure sensitive adhesive 200 may include a polyisobutylene-based material content within a range between, and including, any of the minimum and maximum values noted above.

According to particular embodiments, the pressure sensitive adhesive 200 may include a particular content of the peroxide based additive. For example, the pressure sensitive adhesive 200 may include a peroxide based additive content of at least about 0.25 wt. % for a total weight of the pressure sensitive adhesive 200, such as, at least about 0.30 wt. % or at least about 0.35 wt. % or at least about 0.40 wt. % or at least about 0.45 wt. % or at least about 0.50 wt. % or at least about 0.60 wt. % or at least about 0.70 wt. % or at least about 0.80 wt. % or at least about 0.90 wt. % or even at least about 1.00 wt. %. According to still other embodiments, the pressure sensitive adhesive 200 may include a peroxide based additive content of not greater than about 5.00 wt. % for a total weight of the pressure sensitive adhesive 200, such as, not greater than about 4.75 wt. % or not greater than about 4.50 wt. % or not greater than about 4.25 wt. % or not greater than about 4.00 wt. % or not greater than about 3.50 wt. % or not greater than about 3.00 wt. % or even not greater than about 2.00 wt. %. It will be appreciated that the pressure sensitive adhesive 200 may include a polyisobutylene-based material content of any value between, and including, any of the minimum and maximum values noted above. It will be further appreciated that the pressure sensitive adhesive 200 may include a polyisobutylene-based material content within a range between, and including, any of the minimum and maximum values noted above.

According to particular embodiments, the pressure sensitive adhesive 200 may include a tackifying resin. According to yet other embodiments, the pressure sensitive adhesive 200 may include a particular content of the tackifying resin. For example, the pressure sensitive adhesive 200 may include a tackifying resin content of at least about 0.1 wt. % for a total weight of the pressure sensitive adhesive 200, such as, at least about 0.5 wt. % or at least about 1.00 wt. % or at least about 2.00 wt. % or at least about 3.00 wt. % or at least about 4.00 wt. % or at least about 5.00 wt. % or at least about 6.00 wt. % or at least about 7.00 wt. % or at least about 8.00 wt. % or at least about 9.0 wt. % or even at least about 10.00 wt. %. According to still other embodiments, the pressure sensitive adhesive 200 may include a tackifying resin content of not greater than about 30.00 wt. % for a total weight of the pressure sensitive adhesive 200, such as, not greater than about 29.00 wt. % or not greater than about 28.00 wt. % or not greater than about 27.00 wt. % or not greater than about 26.00 wt. % or not greater than about 25.00 wt. % or not greater than about 24.00 wt. % or not greater than about 23.00 wt. % or not greater than about 22.00 wt. % or not greater than about 21.00 wt. % or even not greater than about 20.00 wt. %. It will be appreciated that the pressure sensitive adhesive 200 may include a polyisobutylene-based material content of any value between, and including, any of the minimum and maximum values noted above. It will be further appreciated that the pressure sensitive adhesive 200 may include a polyisobutylene-based material content within a range between, and including, any of the minimum and maximum values noted above.

According to particular embodiments, the polyisobutylene-based material may include a particular content of polyisobutylene. For example, the polyisobutylene-based material may include a polyisobutylene content of at least about 40.00 wt. % for a total weight of the pressure sensitive adhesive 200, such as, at least about 45.00 wt. % or at least about 50.00 wt. % or at least about 55.00 wt. % or at least about 60.00 wt. % or at least about 65.00 wt. % or at least about 70.00 wt. % or at least about 75.00 wt. % or at least about 80.00 wt. % or at least about 85.00 wt. % or at least about 90.00 wt. % or at least about 91.00 wt. % or at least about 92.00 wt. % or at least about 93.00 wt. % or at least about 94.00 wt. % or at least about 95.00 wt. % or at least about 96.00 wt. % or at least about 97.00 wt. %. According to still other embodiments, the polyisobutylene-based material may include a polyisobutylene content of not greater than about 99.75 wt. % for a total weight of the polyisobutylene-based material, such as, not greater than about 99.50 wt. % or not greater than about 99.25 wt. % or not greater than about 99.00 wt. % or not greater than about 98.75 wt. % or not greater than about 98.50 wt. % or not greater than about 97.00 wt. % or not greater than about 96.50 wt. % or even not greater than about 96.00 wt. %. It will be appreciated that the polyisobutylene-based material may include a polyisobutylene content of any value between, and including, any of the minimum and maximum values noted above. It will be further appreciated that the polyisobutylene-based material may include a polyisobutylene content within a range between, and including, any of the minimum and maximum values noted above.

According to yet other embodiments, the polyisobutylene-based material may consist of polyisobutylene. According to still other embodiments, the polyisobutylene-based material may be polyisobutylene.

According to yet other embodiments, the peroxide based additive may consist of a peroxide material. According to still other embodiments, the peroxide based additive may be peroxide material.

According to still other embodiments, the peroxide material may be a particular peroxide material. For example, the peroxide material may include benzyl peroxide. According to still other embodiments, the peroxide material may consist of benzyl peroxide. According to yet other embodiments, the peroxide material may be benzyl peroxide.

According to still other embodiments, the pressure sensitive adhesive 200 may have a particular Adhesive Electrolyte Exposure Peel Force (AEEPF). For purposes of embodiments described herein, the AEEPF of a particular pressure sensitive adhesive 200 may be defined as a peel force of the adhesive as measured when adhesive is applied to a backing polyethylene terephthalate (PET) backing material or a polyimide (PI) backing material, and then exposed to a dimethylsufoxide (DMSO) aprotic polar solvent or an organic carbonate electrolyte aprotic polar solvent at a temperature of 60° C. for 1 week. According to particulate embodiments, the pressure sensitive adhesive 200 may have an AEEPF of at least about 0.5 N/cm, such as at least about 0.75 N/cm or at least about 1.0 N/cm or at least about 1.25 N/cm or at least about 1.5 N/cm or at least about 1.75 N/cm or at least about 2.0 N/cm or at least about 2.25 N/cm or at least about 2.5 N/cm or at least about 2.75 N/cm or at least about 3.0 N/cm or at least about 3.25 N/cm or at least about 3.5 N/cm or at least about 3.75 N/cm or at least about 4.0 N/cm or at least about 4.25 N/cm or at least about 4.5 N/cm or at least about 4.75 N/cm or at least about 5.0 N/cm or at least about 6.0 N/cm or at least about 7.0 N/cm or at least about 8.0 N/cm or at least about 9.0 N/cm or even at least about 10.0 N/cm. According to still other embodiments, the pressure sensitive adhesive 200 may have an AEEPF of not greater than about 15 N/cm, such as, not greater than not greater than about 14 N/cm or not greater than about 13 N/cm or not greater than about 12 N/cm or not greater than about 11 N/cm or even not greater than about 10 N/cm. It will be appreciated that the pressure sensitive adhesive 200 may have an AEEPF of any value between, and including, any of the minimum and maximum values noted above. It will be further appreciated that the pressure sensitive adhesive 200 may have an AEEPF within a range between, and including, any of the minimum and maximum values noted above.

According to still other embodiments, the pressure sensitive adhesive 200 may have a particular Adhesive Electrolyte Exposure Peel Force Retention (AEEPF-R). For purposes of embodiments described herein, the AEEPF-R of a particular pressure sensitive adhesive 200 is equal to the Adhesive Electrolyte Exposure Peel Force (AEEPF) of the pressure sensitive adhesive 200 divided by the Adhesive Original Peel Force (AOPF) of the pressure sensitive adhesive 200, where the AEEPF of the pressure sensitive adhesive 200 is defined as a peel force of the adhesive as measured when adhesive is applied to a backing polyethylene terephthalate (PET) backing material or a polyimide (PI) backing material, and then exposed to a dimethylsufoxide (DMSO) aprotic polar solvent or an organic carbonate electrolyte aprotic polar solvent at a temperature of 60° C. for 1 week, and the Adhesive Original Peel Force (AOPF) of the pressure sensitive adhesive 200 is defined as the peel force of the adhesive as measured within 1 day of when adhesive is applied to a backing polyethylene terephthalate (PET) backing material or a polyimide (PI) backing material without exposure to a dimethylsufoxide (DMSO) aprotic polar solvent or an organic carbonate electrolyte aprotic polar solvent. According to particulate embodiments, the pressure sensitive adhesive 200 may have an AEEPF-R of at least about 0.40, such as at least about 0.45 or at least about 0.50 or at least about 0.55 or at least about 0.60 or at least about 0.65 or at least about 0.70 or at least about 0.75 or at least about 0.80 or at least about 0.85 or at least about 0.90 or even at least about 0.95. According to still other embodiments, the pressure sensitive adhesive 200 may have an AEEPF-R of not greater than about 1.0, such as, not greater than not greater than about 0.99 or not greater than about 0.98 or not greater than about 0.97 or not greater than about 0.96 or even not greater than about 0.95. It will be appreciated that the pressure sensitive adhesive 200 may have an AEEPF-R of any value between, and including, any of the minimum and maximum values noted above. It will be further appreciated that the pressure sensitive adhesive 200 may have an AEEPF-R within a range between, and including, any of the minimum and maximum values noted above.

Turning now to embodiments of tape that may include a pressure sensitive adhesive 200 as described herein. Such additional embodiments described herein are generally directed to a tape that may include a backing layer and a layer of pressure sensitive adhesive 200 overlying the backing layer. According to certain embodiments, the pressure sensitive adhesive 200 may include a polyisobutylene-based material, and a peroxide based additive.

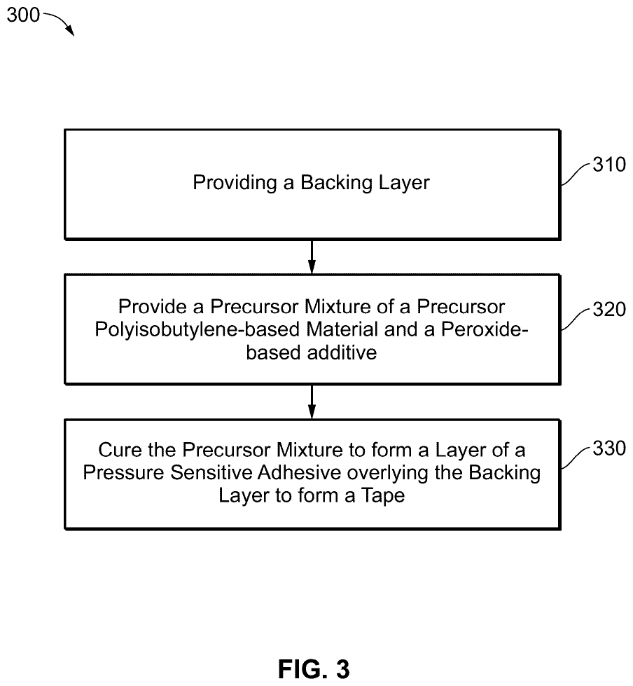

Referring next to a method of forming a tape, FIG. 3 includes a diagram showing a forming method 300 for forming a tape according to embodiments described herein. According to particular embodiments, the forming method 300 may include a first step 310 of providing a backing layer, a second step 320 of providing a precursor mixture of a precursor polyisobutylene-based material, and a peroxide-based additive, and a third step 330 of curing the precursor mixture to form a layer of pressure sensitive adhesive overlying the backing layer to form the tape.

According to still other embodiments, the backing layer may include cloth, vulcanized fiber, paper, nonwoven materials, fibrous reinforced thermoplastic backing, polymeric films, substrates containing hooked stems, looped fabrics, metal foils, mesh, foam backings, and laminated multilayer combinations thereof. Cloth backings can be untreated, saturated, pre-sized, backsized, porous, or sealed, and they may be woven or stitch bonded. The cloth backings may include fibers or yarns of cotton, polyester, rayon, silk, nylon or blends thereof. The cloth backings can be provided as laminates with different backing materials described herein. Paper backings also can be saturated, barrier coated, pre-sized, backsized, untreated, or fiber-reinforced. The paper backings also can be provided as laminates with a different type of backing material. Nonwoven backings include scrims and laminates to different backing materials mentioned herein. The nonwovens may be formed of cellulosic fibers, synthetic fibers or blends thereof. Polymeric backings include polyolefin or polyester films. The polymeric backings can be provided as blown film, or as laminates of different types of polymeric materials, or laminates of polymeric films with a non-polymeric type of backing material. The backing can also be a stem web used alone or incorporating a nonwoven, or as a laminate with a different type of backing. The loop fabric backing can be brushed nylon, brushed polyester, polyester stitched loop, and loop material laminated to a different type of backing material. The foam backing may be a natural sponge material or polyurethane foam and the like. The foam backing also can be laminated to a different type of backing material. The mesh backings can be made of polymeric or metal open-weave scrims.

According to particular embodiments, the precursor mixture may include a particular content of the precursor polyisobutylene-based material. For example, the precursor mixture may include a precursor polyisobutylene-based material content of at least about 40.00 wt. % for a total weight of the precursor mixture, such as, at least about 45.00 wt. % or at least about 50.00 wt. % or at least about 55.00 wt. % or at least about 60.00 wt. % or at least about 65.00 wt. % or at least about 70.00 wt. % or at least about 75.00 wt. % or at least about 80.00 wt. % or at least about 85.00 wt. % or at least about 90.00 wt. % or at least about 91.00 wt. % or at least about 92.00 wt. % or at least about 93.00 wt. % or at least about 94.00 wt. % or at least about 95.00 wt. % or at least about 96.00 wt. % or at least about 97.00 wt. %. According to still other embodiments, the precursor mixture may include a precursor polyisobutylene-based material content of not greater than about 99.75 wt. % for a total weight of the precursor mixture, such as, not greater than about 99.50 wt. % or not greater than about 99.25 wt. % or not greater than about 99.00 wt. % or not greater than about 98.75 wt. % or not greater than about 98.50 wt. % or not greater than about 97.00 wt. % or not greater than about 96.50 wt. % or even not greater than about 96.00 wt. %. It will be appreciated that the precursor mixture may include a precursor polyisobutylene-based material content of any value between, and including, any of the minimum and maximum values noted above. It will be further appreciated that the precursor mixture may include a precursor polyisobutylene-based material content within a range between, and including, any of the minimum and maximum values noted above.

According to particular embodiments, the precursor mixture may include a particular content of the precursor peroxide based additive. For example, the precursor mixture may include a precursor peroxide based additive content of at least about 0.25 wt. % for a total weight of the precursor mixture, such as, at least about 0.30 wt. % or at least about 0.35 wt. % or at least about 0.40 wt. % or at least about 0.45 wt. % or at least about 0.50 wt. % or at least about 0.60 wt. % or at least about 0.70 wt. % or at least about 0.80 wt. % or at least about 0.90 wt. % or even at least about 1.00 wt. %. According to still other embodiments, the precursor mixture may include a precursor peroxide based additive content of not greater than about 5.00 wt. % for a total weight of the precursor mixture, such as, not greater than about 4.75 wt. % or not greater than about 4.50 wt. % or not greater than about 4.25 wt. % or not greater than about 4.00 wt. % or not greater than about 3.50 wt. % or not greater than about 3.00 wt. % or even not greater than about 2.00 wt. %. It will be appreciated that the precursor mixture may include a precursor polyisobutylene-based material content of any value between, and including, any of the minimum and maximum values noted above. It will be further appreciated that the precursor mixture may include a precursor polyisobutylene-based material content within a range between, and including, any of the minimum and maximum values noted above.

According to particular embodiments, the precursor mixture may include a precursor tackifying resin. According to yet other embodiments, the precursor mixture may include a particular content of the precursor tackifying resin. For example, the precursor mixture may include a precursor tackifying resin content of at least about 0.1 wt. % for a total weight of the precursor mixture, such as, at least about 0.5 wt. % or at least about 1.00 wt. % or at least about 2.00 wt. % or at least about 3.00 wt. % or at least about 4.00 wt. % or at least about 5.00 wt. % or at least about 6.00 wt. % or at least about 7.00 wt. % or at least about 8.00 wt. % or at least about 9.0 wt. % or even at least about 10.00 wt. %. According to still other embodiments, the precursor mixture may include a precursor tackifying resin content of not greater than about 30.00 wt. % for a total weight of the precursor mixture, such as, not greater than about 29.00 wt. % or not greater than about 28.00 wt. % or not greater than about 27.00 wt. % or not greater than about 26.00 wt. % or not greater than about 25.00 wt. % or not greater than about 24.00 wt. % or not greater than about 23.00 wt. % or not greater than about 22.00 wt. % or not greater than about 21.00 wt. % or even not greater than about 20.00 wt. %. It will be appreciated that the precursor mixture may include a precursor polyisobutylene-based material content of any value between, and including, any of the minimum and maximum values noted above. It will be further appreciated that the precursor mixture may include a precursor polyisobutylene-based material content within a range between, and including, any of the minimum and maximum values noted above.

According to particular embodiments, the precursor polyisobutylene-based material may include a particular content of polyisobutylene. For example, the precursor polyisobutylene-based material may include a polyisobutylene content of at least about 40.00 wt. % for a total weight of the precursor mixture, such as, at least about 45.00 wt. % or at least about 50.00 wt. % or at least about 55.00 wt. % or at least about 60.00 wt. % or at least about 65.00 wt. % or at least about 70.00 wt. % or at least about 75.00 wt. % or at least about 80.00 wt. % or at least about 85.00 wt. % or at least about 90.00 wt. % or at least about 91.00 wt. % or at least about 92.00 wt. % or at least about 93.00 wt. % or at least about 94.00 wt. % or at least about 95.00 wt. % or at least about 96.00 wt. % or at least about 97.00 wt. %. According to still other embodiments, the precursor polyisobutylene-based material may include a polyisobutylene content of not greater than about 99.75 wt. % for a total weight of the precursor polyisobutylene-based material, such as, not greater than about 99.50 wt. % or not greater than about 99.25 wt. % or not greater than about 99.00 wt. % or not greater than about 98.75 wt. % or not greater than about 98.50 wt. % or not greater than about 97.00 wt. % or not greater than about 96.50 wt. % or even not greater than about 96.00 wt. %. It will be appreciated that the precursor polyisobutylene-based material may include a polyisobutylene content of any value between, and including, any of the minimum and maximum values noted above. It will be further appreciated that the precursor polyisobutylene-based material may include a polyisobutylene content within a range between, and including, any of the minimum and maximum values noted above.

According to yet other embodiments, the precursor polyisobutylene-based material may consist of polyisobutylene. According to still other embodiments, the precursor polyisobutylene-based material may be polyisobutylene.

According to yet other embodiments, the precursor peroxide based additive may consist of a peroxide material. According to still other embodiments, the precursor peroxide based additive may be peroxide material.

According to still other embodiments, the peroxide material may be a particular peroxide material. For example, the peroxide material may include benzyl peroxide. According to still other embodiments, the peroxide material may consist of benzyl peroxide. According to yet other embodiments, the peroxide material may be benzyl peroxide.

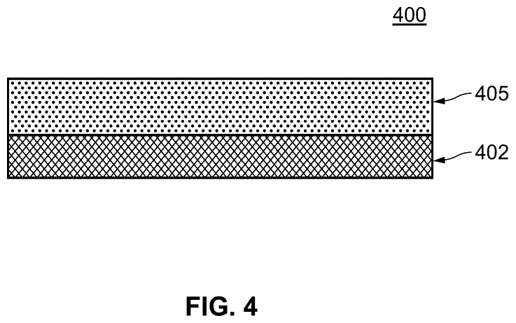

Referring now to embodiments of the tape formed according to forming method 300, FIG. 4 includes diagram of an adhesive tape 400. As shown in FIG. 4, the adhesive tape 400 may include a backing layer 402, and a layer of pressure sensitive adhesive 405 overlying a surface of the backing layer 402. According to certain embodiments, the pressure sensitive adhesive 405 may include a polyisobutylene-based material, and a peroxide based additive.

According to still other embodiments, the backing layer 402 may include cloth, vulcanized fiber, paper, nonwoven materials, fibrous reinforced thermoplastic backing, polymeric films, substrates containing hooked stems, looped fabrics, metal foils, mesh, foam backings, and laminated multilayer combinations thereof. Cloth backings can be untreated, saturated, pre-sized, backsized, porous, or sealed, and they may be woven or stitch bonded. The cloth backings may include fibers or yarns of cotton, polyester, rayon, silk, nylon or blends thereof. The cloth backings can be provided as laminates with different backing materials described herein. Paper backings also can be saturated, barrier coated, pre-sized, backsized, untreated, or fiber-reinforced. The paper backings also can be provided as laminates with a different type of backing material. Nonwoven backings include scrims and laminates to different backing materials mentioned herein. The nonwovens may be formed of cellulosic fibers, synthetic fibers or blends thereof. Polymeric backings include polyolefin or polyester films. The polymeric backings can be provided as blown film, or as laminates of different types of polymeric materials, or laminates of polymeric films with a non-polymeric type of backing material. The backing can also be a stem web used alone or incorporating a nonwoven, or as a laminate with a different type of backing. The loop fabric backing can be brushed nylon, brushed polyester, polyester stitched loop, and loop material laminated to a different type of backing material. The foam backing may be a natural sponge material or polyurethane foam and the like. The foam backing also can be laminated to a different type of backing material. The mesh backings can be made of polymeric or metal open-weave scrims.

According to still other embodiments, the backing layer 402 may have a particular thickness. For example, the backing layer 402 may have a thickness of at least about 5 microns, such as, at least about 10 microns or at least about 20 microns or at least about 30 microns or at least about 40 microns or at least about 50 microns or at least about 60 microns or at least about 70 microns or at least about 80 microns or at least about 90 microns or at least about 100 microns or at least about 125 microns or at least about 150 microns or at least about 175 microns or at least about 200 microns or at least about 225 microns or even at least about 250 microns. According to still other embodiments, the backing layer 402 may have a thickness of not greater than about 500 microns, such as not greater than about 450 microns or not greater than about 400 microns or even not greater than about 350 microns. It will be appreciated that the backing layer 402 may have a thickness of any value between, and including, any of the minimum and maximum values noted above. It will be further appreciated that the backing layer 402 may have a thickness within a range between, and including, any of the minimum and maximum values noted above.

According to particular embodiments, the pressure sensitive adhesive 405 may include a particular content of the polyisobutylene-based material. For example, the pressure sensitive adhesive 405 may include a polyisobutylene-based material content of at least about 40.00 wt. % for a total weight of the pressure sensitive adhesive 405, such as, at least about 45.00 wt. % or at least about 50.00 wt. % or at least about 55.00 wt. % or at least about 60.00 wt. % or at least about 65.00 wt. % or at least about 70.00 wt. % or at least about 75.00 wt. % or at least about 80.00 wt. % or at least about 85.00 wt. % or at least about 90.00 wt. % or at least about 91.00 wt. % or at least about 92.00 wt. % or at least about 93.00 wt. % or at least about 94.00 wt. % or at least about 95.00 wt. % or at least about 96.00 wt. % or at least about 97.00 wt. %. According to still other embodiments, the pressure sensitive adhesive 405 may include a polyisobutylene-based material content of not greater than about 99.75 wt. % for a total weight of the pressure sensitive adhesive 405, such as, not greater than about 99.50 wt. % or not greater than about 99.25 wt. % or not greater than about 99.00 wt. % or not greater than about 98.75 wt. % or not greater than about 98.50 wt. % or not greater than about 97.00 wt. % or not greater than about 96.50 wt. % or even not greater than about 96.00 wt. %. It will be appreciated that the pressure sensitive adhesive 405 may include a polyisobutylene-based material content of any value between, and including, any of the minimum and maximum values noted above. It will be further appreciated that the pressure sensitive adhesive 405 may include a polyisobutylene-based material content within a range between, and including, any of the minimum and maximum values noted above.

According to particular embodiments, the pressure sensitive adhesive 405 may include a particular content of the peroxide based additive. For example, the pressure sensitive adhesive 405 may include a peroxide based additive content of at least about 0.25 wt. % for a total weight of the pressure sensitive adhesive 405, such as, at least about 0.30 wt. % or at least about 0.35 wt. % or at least about 0.40 wt. % or at least about 0.45 wt. % or at least about 0.50 wt. % or at least about 0.60 wt. % or at least about 0.70 wt. % or at least about 0.80 wt. % or at least about 0.90 wt. % or even at least about 1.00 wt. %. According to still other embodiments, the pressure sensitive adhesive 405 may include a peroxide based additive content of not greater than about 5.00 wt. % for a total weight of the pressure sensitive adhesive 405, such as, not greater than about 4.75 wt. % or not greater than about 4.50 wt. % or not greater than about 4.25 wt. % or not greater than about 4.00 wt. % or not greater than about 3.50 wt. % or not greater than about 3.00 wt. % or even not greater than about 2.00 wt. %. It will be appreciated that the pressure sensitive adhesive 405 may include a polyisobutylene-based material content of any value between, and including, any of the minimum and maximum values noted above. It will be further appreciated that the pressure sensitive adhesive 405 may include a polyisobutylene-based material content within a range between, and including, any of the minimum and maximum values noted above.

According to particular embodiments, the pressure sensitive adhesive 405 may include a tackifying resin. According to yet other embodiments, the pressure sensitive adhesive 405 may include a particular content of the tackifying resin. For example, the pressure sensitive adhesive 405 may include a tackifying resin content of at least about 0.1 wt. % for a total weight of the pressure sensitive adhesive 405, such as, at least about 0.5 wt. % or at least about 1.00 wt. % or at least about 2.00 wt. % or at least about 3.00 wt. % or at least about 4.00 wt. % or at least about 5.00 wt. % or at least about 6.00 wt. % or at least about 7.00 wt. % or at least about 8.00 wt. % or at least about 9.0 wt. % or even at least about 10.00 wt. %. According to still other embodiments, the pressure sensitive adhesive 405 may include a tackifying resin content of not greater than about 30.00 wt. % for a total weight of the pressure sensitive adhesive 405, such as, not greater than about 29.00 wt. % or not greater than about 28.00 wt. % or not greater than about 27.00 wt. % or not greater than about 26.00 wt. % or not greater than about 25.00 wt. % or not greater than about 24.00 wt. % or not greater than about 23.00 wt. % or not greater than about 22.00 wt. % or not greater than about 21.00 wt. % or even not greater than about 20.00 wt. %. It will be appreciated that the pressure sensitive adhesive 405 may include a polyisobutylene-based material content of any value between, and including, any of the minimum and maximum values noted above. It will be further appreciated that the pressure sensitive adhesive 405 may include a polyisobutylene-based material content within a range between, and including, any of the minimum and maximum values noted above.

According to particular embodiments, the polyisobutylene-based material may include a particular content of polyisobutylene. For example, the polyisobutylene-based material may include a polyisobutylene content of at least about 40.00 wt. % for a total weight of the pressure sensitive adhesive 405, such as, at least about 45.00 wt. % or at least about 50.00 wt. % or at least about 55.00 wt. % or at least about 60.00 wt. % or at least about 65.00 wt. % or at least about 70.00 wt. % or at least about 75.00 wt. % or at least about 80.00 wt. % or at least about 85.00 wt. % or at least about 90.00 wt. % or at least about 91.00 wt. % or at least about 92.00 wt. % or at least about 93.00 wt. % or at least about 94.00 wt. % or at least about 95.00 wt. % or at least about 96.00 wt. % or at least about 97.00 wt. %. According to still other embodiments, the polyisobutylene-based material may include a polyisobutylene content of not greater than about 99.75 wt. % for a total weight of the polyisobutylene-based material, such as, not greater than about 99.50 wt. % or not greater than about 99.25 wt. % or not greater than about 99.00 wt. % or not greater than about 98.75 wt. % or not greater than about 98.50 wt. % or not greater than about 97.00 wt. % or not greater than about 96.50 wt. % or even not greater than about 96.00 wt. %. It will be appreciated that the polyisobutylene-based material may include a polyisobutylene content of any value between, and including, any of the minimum and maximum values noted above. It will be further appreciated that the polyisobutylene-based material may include a polyisobutylene content within a range between, and including, any of the minimum and maximum values noted above.

According to yet other embodiments, the polyisobutylene-based material may consist of polyisobutylene. According to still other embodiments, the polyisobutylene-based material may be polyisobutylene.

According to yet other embodiments, the peroxide based additive may consist of a peroxide material. According to still other embodiments, the peroxide based additive may be peroxide material.

According to still other embodiments, the peroxide material may be a particular peroxide material. For example, the peroxide material may include benzyl peroxide. According to still other embodiments, the peroxide material may consist of benzyl peroxide. According to yet other embodiments, the peroxide material may be benzyl peroxide.

According to still other embodiments, the layer of pressure sensitive adhesive 405 may have a particular thickness. For example, the layer of pressure sensitive adhesive 405 may have a thickness of at least about 4 microns, such as, at least about 5 microns or at least about 10 microns or at least about 15 microns or at least about 20 microns or at least about 25 microns or at least about 30 microns or at least about 35 microns or at least about 40 microns or at least about 45 microns or at least about 50 microns or at least about 60 microns or at least about 70 microns or at least about 80 microns or at least about 90 microns or even at least about 100 microns. According to still other embodiments, the layer of pressure sensitive adhesive 405 may have a thickness of not greater than about 200 microns, such as not greater than about 175 microns or not greater than about 150 microns or even not greater than about 125 microns. It will be appreciated that the layer of pressure sensitive adhesive 405 may have a thickness of any value between, and including, any of the minimum and maximum values noted above. It will be further appreciated that the layer of pressure sensitive adhesive 405 may have a thickness within a range between, and including, any of the minimum and maximum values noted above.

According to still other embodiments, the pressure sensitive adhesive 405 may have a particular Adhesive Electrolyte Exposure Peel Force (AEEPF). For purposes of embodiments described herein, the AEEPF of a particular pressure sensitive adhesive 405 may be defined as a peel force of the adhesive as measured when adhesive is applied to a backing polyethylene terephthalate (PET) backing material or a polyimide (PI) backing material, and then exposed to a dimethylsufoxide (DMSO) aprotic polar solvent or an organic carbonate electrolyte aprotic polar solvent at a temperature of 60° C. for 1 week. According to particulate embodiments, the pressure sensitive adhesive 405 may have an AEEPF of at least about 0.5 N/cm, such as at least about 0.75 N/cm or at least about 1.0 N/cm or at least about 1.25 N/cm or at least about 1.5 N/cm or at least about 1.75 N/cm or at least about 2.0 N/cm or at least about 2.25 N/cm or at least about 2.5 N/cm or at least about 2.75 N/cm or at least about 3.0 N/cm or at least about 3.25 N/cm or at least about 3.5 N/cm or at least about 3.75 N/cm or at least about 4.0 N/cm or at least about 4.25 N/cm or at least about 4.5 N/cm or at least about 4.75 N/cm or at least about 5.0 N/cm or at least about 6.0 N/cm or at least about 7.0 N/cm or at least about 8.0 N/cm or at least about 9.0 N/cm or even at least about 10.0 N/cm. According to still other embodiments, the pressure sensitive adhesive 405 may have an AEEPF of not greater than about 15 N/cm, such as, not greater than not greater than about 14 N/cm or not greater than about 13 N/cm or not greater than about 12 N/cm or not greater than about 11 N/cm or even not greater than about 10 N/cm. It will be appreciated that the pressure sensitive adhesive 405 may have an AEEPF of any value between, and including, any of the minimum and maximum values noted above. It will be further appreciated that the pressure sensitive adhesive 405 may have an AEEPF within a range between, and including, any of the minimum and maximum values noted above.

According to still other embodiments, the pressure sensitive adhesive 405 may have a particular Adhesive Electrolyte Exposure Peel Force Retention (AEEPF-R). For purposes of embodiments described herein, the AEEPF-R of a particular pressure sensitive adhesive 405 is equal to the Adhesive Electrolyte Exposure Peel Force (AEEPF) of the pressure sensitive adhesive 405 divided by the Adhesive Original Peel Force (AOPF) of the pressure sensitive adhesive 405, where the AEEPF of the pressure sensitive adhesive 405 is defined as a peel force of the adhesive as measured when adhesive is applied to a backing polyethylene terephthalate (PET) backing material or a polyimide (PI) backing material, and then exposed to a dimethylsufoxide (DMSO) aprotic polar solvent or an organic carbonate electrolyte aprotic polar solvent at a temperature of 60° C. for 1 week, and the Adhesive Original Peel Force (AOPF) of the pressure sensitive adhesive 405 is defined as the peel force of the adhesive as measured within 1 day of when adhesive is applied to a backing polyethylene terephthalate (PET) backing material or a polyimide (PI) backing material without exposure to a dimethylsufoxide (DMSO) aprotic polar solvent or an organic carbonate electrolyte aprotic polar solvent. According to particulate embodiments, the pressure sensitive adhesive 405 may have an AEEPF-R of at least about 0.40, such as at least about 0.45 or at least about 0.50 or at least about 0.55 or at least about 0.60 or at least about 0.65 or at least about 0.70 or at least about 0.75 or at least about 0.80 or at least about 0.85 or at least about 0.90 or even at least about 0.95. According to still other embodiments, the pressure sensitive adhesive 405 may have an AEEPF-R of not greater than about 1.0, such as, not greater than not greater than about 0.99 or not greater than about 0.98 or not greater than about 0.97 or not greater than about 0.96 or even not greater than about 0.95. It will be appreciated that the pressure sensitive adhesive 405 may have an AEEPF-R of any value between, and including, any of the minimum and maximum values noted above. It will be further appreciated that the pressure sensitive adhesive 405 may have an AEEPF-R within a range between, and including, any of the minimum and maximum values noted above.

According to still other embodiments, the adhesive tape 400 may have a particular thickness. For example, the adhesive tape 400 may have a thickness of at least about 10 microns, such as, at least about 20 microns or at least about 30 microns or at least about 40 microns or at least about 50 microns or at least about 60 microns or at least about 70 microns or at least about 80 microns or at least about 90 microns or at least about 100 microns or at least about 125 microns or at least about 150 microns or at least about 175 microns or at least about 200 microns or at least about 225 microns or even at least about 250 microns. According to still other embodiments, the adhesive tape 400 may have a thickness of not greater than about 500 microns, such as not greater than about 450 microns or not greater than about 400 microns or even not greater than about 350 microns. It will be appreciated that the adhesive tape 400 may have a thickness of any value between, and including, any of the minimum and maximum values noted above. It will be further appreciated that the adhesive tape 400 may have a thickness within a range between, and including, any of the minimum and maximum values noted above.

According to still other embodiments, the adhesive tape 400 may have a particular Tape Electrolyte Exposure Peel Force (TEEPF). For purposes of embodiments described herein, the TEEPF of a particular adhesive tape 400 may be defined as a peel force of the adhesive of the tape as measured when adhesive is applied to the tape's backing, and then exposed to a dimethylsufoxide (DMSO) aprotic polar solvent or an organic carbonate electrolyte aprotic polar solvent at a temperature of 60° C. for 1 week. According to particulate embodiments, the adhesive tape 400 may have a TEEPF of at least about 0.5 N/cm, such as at least about 0.75 N/cm or at least about 1.0 N/cm or at least about 1.25 N/cm or at least about 1.5 N/cm or at least about 1.75 N/cm or at least about 2.0 N/cm or at least about 2.25 N/cm or at least about 2.5 N/cm or at least about 2.75 N/cm or at least about 3.0 N/cm or at least about 3.25 N/cm or at least about 3.5 N/cm or at least about 3.75 N/cm or at least about 4.0 N/cm or at least about 4.25 N/cm or at least about 4.5 N/cm or at least about 4.75 N/cm or at least about 5.0 N/cm or at least about 6.0 N/cm or at least about 7.0 N/cm or at least about 8.0 N/cm or at least about 9.0 N/cm or even at least about 10.0 N/cm. According to still other embodiments, the adhesive tape 400 may have a TEEPF of not greater than about 15 N/cm, such as, not greater than not greater than about 14 N/cm or not greater than about 13 N/cm or not greater than about 12 N/cm or not greater than about 11 N/cm or even not greater than about 10 N/cm. It will be appreciated that the adhesive tape 400 may have a TEEPF of any value between, and including, any of the minimum and maximum values noted above. It will be further appreciated that the adhesive tape 400 may have a TEEPF within a range between, and including, any of the minimum and maximum values noted above.

According to still other embodiments, the adhesive tape 400 may have a particular Tape Electrolyte Exposure Peel Force Retention (TEEPF-R). For purposes of embodiments described herein, the TEEPF-R of a particular adhesive tape 400 is equal to the Tape Electrolyte Exposure Peel Force (TEEPF) of the adhesive tape 400 divided by the Tape Original Peel Force (TOPF) of the adhesive tape 400, where the TEEPF of the adhesive tape 400 is defined as a peel force of the adhesive of the tape as measured when adhesive is applied to the tape's backing, and then exposed to a dimethylsufoxide (DMSO) aprotic polar solvent or an organic carbonate electrolyte aprotic polar solvent at a temperature of 60° C. for 1 week, and the Tape Original Peel Force (TOPF) of the adhesive tape 400 is defined as the peel force of the adhesive of the tape as measured within 1 day of when adhesive is applied to the tapes backing without exposure to a dimethylsufoxide (DMSO) aprotic polar solvent or an organic carbonate electrolyte aprotic polar solvent. According to particulate embodiments, the adhesive tape 400 may have a TEEPF-R of at least about 0.40, such as at least about 0.45 or at least about 0.50 or at least about 0.55 or at least about 0.60 or at least about 0.65 or at least about 0.70 or at least about 0.75 or at least about 0.80 or at least about 0.85 or at least about 0.90 or even at least about 0.95. According to still other embodiments, the adhesive tape 400 may have a TEEPF-R of not greater than about 1.0, such as, not greater than not greater than about 0.99 or not greater than about 0.98 or not greater than about 0.97 or not greater than about 0.96 or even not greater than about 0.95. It will be appreciated that the adhesive tape 400 may have a TEEPF-R of any value between, and including, any of the minimum and maximum values noted above. It will be further appreciated that the adhesive tape 400 may have a TEEPF-R within a range between, and including, any of the minimum and maximum values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A pressure sensitive adhesive comprising: a polyisobutylene based material, and a peroxide based additive, wherein the pressure sensitive adhesive comprises an Adhesive Electrolyte Exposure Peel Force (AEEPF) of at least about 0.5 N/cm.

Embodiment 2. A pressure sensitive adhesive comprising: a polyisobutylene based material, and a peroxide based additive, wherein the pressure sensitive adhesive comprises an Adhesive Electrolyte Exposure Peel Force Retention (AEEPF-R) of at least about 0.4, where the AEEPF-R is equal to Adhesive Electrolyte Exposure Peel Force (AEEPF) of the pressure sensitive adhesive divided by the Adhesive Original Peel Force (AOPF) of the pressure sensitive adhesive.

Embodiment 3. The pressure sensitive adhesive of any one of embodiments 1, and 2, wherein the pressure sensitive adhesive comprises an Adhesive Electrolyte Exposure Peel Force (AEEPF) of at least about 0.5 N/cm.

Embodiment 4. The pressure sensitive adhesive of any one of embodiments 1, and 2, wherein the pressure sensitive adhesive comprises an Adhesive Electrolyte Exposure Peel Force (AEEPF) of not greater than about 15 N/cm.

Embodiment 5. The pressure sensitive adhesive of any one of embodiments 1, and 2, wherein the pressure sensitive adhesive comprises an Adhesive Electrolyte Exposure Peel Force Retention (AEEPF-R) of at least about 0.4, where the AEEPF is equal to Adhesive Electrolyte Exposure Peel Force (AEEPF) of the pressure sensitive adhesive divided by the Adhesive Original Peel Force (AOPF) of the pressure sensitive adhesive.

Embodiment 6. The pressure sensitive adhesive of any one of embodiments 1, and 2, wherein the pressure sensitive adhesive comprises an Adhesive Electrolyte Exposure Peel Force Retention (AEEPF-R) of not greater than about 1.0, where the AEEPF is equal to Adhesive Electrolyte Exposure Peel Force (AEEPF) of the pressure sensitive adhesive divided by the Adhesive Original Peel Force (AOPF) of the pressure sensitive adhesive.

Embodiment 7. The pressure sensitive adhesive of any one of embodiments 1, and 2, wherein the pressure sensitive adhesive comprises a polyisobutylene based material content of at least about 40.00 wt. % for a total weight of the pressure sensitive adhesive.

Embodiment 8. The pressure sensitive adhesive of any one of embodiments 1, and 2, wherein the pressure sensitive adhesive comprises a polyisobutylene based material content of not greater than about 99.75 wt. % for a total weight of the pressure sensitive adhesive.

Embodiment 9. The pressure sensitive adhesive of any one of embodiments 1, and 2, wherein the pressure sensitive adhesive comprises a peroxide based additive content of at least about 0.25 wt. % for a total weight of the pressure sensitive adhesive.

Embodiment 10. The pressure sensitive adhesive of any one of embodiments 1, and 2, wherein the pressure sensitive adhesive comprises a peroxide based additive content of not greater than about 5.0 wt. % for a total weight of the pressure sensitive adhesive.

Embodiment 11. The pressure sensitive adhesive of any one of embodiments 1, and 2, wherein the pressure sensitive adhesive comprises a tackifying resin content of at least about 0.1 wt. % a total weight of the pressure sensitive adhesive.

Embodiment 12. The pressure sensitive adhesive of any one of embodiments 1, and 2, wherein the pressure sensitive adhesive comprises a tackifying resin content of not greater than about 30.0 wt. % a total weight of the pressure sensitive adhesive.

Embodiment 13. The pressure sensitive adhesive of any one of embodiments 1, and 2, wherein the polyisobutylene based material comprises a polyisobutylene content of at least about 40 wt. % for a total weight of the polyisobutylene based material.

Embodiment 14. The pressure sensitive adhesive of any one of embodiments 1, and 2, wherein the polyisobutylene based material comprises a polyisobutylene content of not greater than about 99.75 wt. % for a total weight of the polyisobutylene based material.

Embodiment 15. The pressure sensitive adhesive of any one of embodiments 1, and 2, wherein the polyisobutylene based material consists of polyisobutylene.

Embodiment 16. The pressure sensitive adhesive of any one of embodiments 1, and 2, wherein the peroxide based additive comprises a peroxide content of at least about 5.0 wt. % for a total weight of the peroxide based additive.

Embodiment 17. The pressure sensitive adhesive of any one of embodiments 1, and 2, wherein the peroxide based additive comprises a peroxide content of not greater than about 30.0 wt. % for a total weight of the peroxide based additive.

Embodiment 18. The pressure sensitive adhesive of any one of embodiments 1, and 2, wherein the peroxide based additive consists of peroxide.

Embodiment 19. The pressure sensitive adhesive of any one of embodiments 1, and 2, wherein the peroxide based additive comprises a benzyl peroxide.

Embodiment 20. The pressure sensitive adhesive of any one of embodiments 1, and 2, wherein the peroxide based additive consists of a benzyl peroxide.

Embodiment 21. A adhesive tape comprising: a backing material, and a pressure sensitive adhesive applied over a first surface of the backing material, wherein the pressure sensitive adhesive comprises: a polyisobutylene based material, and a peroxide based additive, wherein the adhesive tape comprises a Tape Electrolyte Exposure Peel Force (TEEPF) of at least about 0.5 N/cm.

Embodiment 22. A adhesive tape comprising: a backing material, and a pressure sensitive adhesive applied over a first surface of the backing material, wherein the pressure sensitive adhesive comprises: a polyisobutylene based material, and a peroxide based additive, wherein the adhesive tape comprises a Tape Electrolyte Exposure Peel Force Retention (TEEPF-R) of at least about 0.4, where the TEEPF-R is equal to Tape Electrolyte Exposure Peel Force (TEEPF) of the adhesive tape divided by the Tape Original Peel Force (TOPF) of the adhesive tape.

Embodiment 23. The adhesive tape of any one of embodiments 21, and 22, wherein the pressure sensitive adhesive comprises an Adhesive Electrolyte Exposure Peel Force (AEEPF) of at least about 0.5 N/cm.

Embodiment 24. The adhesive tape of any one of embodiments 21, and 22, wherein the pressure sensitive adhesive comprises an Adhesive Electrolyte Exposure Peel Force (AEEPF) of not greater than about 15 N/cm.

Embodiment 25. The adhesive tape of any one of embodiments 21, and 22, wherein the pressure sensitive adhesive comprises an Adhesive Electrolyte Exposure Peel Force Retention (AEEPF-R) of at least about 0.4, where the AEEPF is equal to Adhesive Electrolyte Exposure Peel Force (AEEPF) of the pressure sensitive adhesive divided by the Adhesive Original Peel Force (AOPF) of the pressure sensitive adhesive.

Embodiment 26. The adhesive tape of any one of embodiments 21, and 22, wherein the pressure sensitive adhesive comprises an Adhesive Electrolyte Exposure Peel Force Retention (AEEPF-R) of not greater than about 1.0, where the AEEPF is equal to Adhesive Electrolyte Exposure Peel Force (AEEPF) of the pressure sensitive adhesive divided by the Adhesive Original Peel Force (AOPF) of the pressure sensitive adhesive.

Embodiment 27. The adhesive tape of any one of embodiments 21, and 22, wherein the pressure sensitive adhesive comprises a polyisobutylene based material content of at least about 40.00 wt. % for a total weight of the pressure sensitive adhesive.

Embodiment 28. The adhesive tape of any one of embodiments 21, and 22, wherein the pressure sensitive adhesive comprises a polyisobutylene based material content of not greater than about 99.75 wt. % for a total weight of the pressure sensitive adhesive.

Embodiment 29. The adhesive tape of any one of embodiments 21, and 22, wherein the pressure sensitive adhesive comprises a peroxide based additive content of at least about 0.25 wt. % for a total weight of the pressure sensitive adhesive.

Embodiment 30. The adhesive tape of any one of embodiments 21, and 22, wherein the pressure sensitive adhesive comprises a peroxide based additive content of not greater than about 5.0 wt. % for a total weight of the pressure sensitive adhesive.

Embodiment 31. The adhesive tape of any one of embodiments 21, and 22, wherein the pressure sensitive adhesive comprises a tackifying resin content of at least about 0.1 wt. % a total weight of the pressure sensitive adhesive.

Embodiment 32. The adhesive tape of any one of embodiments 21, and 22, wherein the pressure sensitive adhesive comprises a tackifying resin content of not greater than about 30.0 wt. % a total weight of the pressure sensitive adhesive.

Embodiment 33. The adhesive tape of any one of embodiments 21, and 22, wherein the polyisobutylene based material comprises a polyisobutylene content of at least about 40 wt. % for a total weight of the polyisobutylene based material.

Embodiment 34. The adhesive tape of any one of embodiments 21, and 22, wherein the polyisobutylene based material comprises a polyisobutylene content of not greater than about 99.75 wt. % for a total weight of the polyisobutylene based material.

Embodiment 35. The adhesive tape of any one of embodiments 21, and 22, wherein the polyisobutylene based material consists of polyisobutylene.

Embodiment 36. The adhesive tape of any one of embodiments 21, and 22, wherein the peroxide based additive comprises a peroxide content of at least about 5.0 wt. % for a total weight of the peroxide based additive.

Embodiment 37. The adhesive tape of any one of embodiments 21, and 22, wherein the peroxide based additive comprises a peroxide content of not greater than about 30.0 wt. % for a total weight of the peroxide based additive.

Embodiment 38. The adhesive tape of any one of embodiments 21, and 22, wherein the peroxide based additive consists of peroxide.

Embodiment 39. The adhesive tape of any one of embodiments 21, and 22, wherein the peroxide based additive comprises a benzyl peroxide.

Embodiment 40. The adhesive tape of any one of embodiments 21, and 22, wherein the peroxide based additive consists of a benzyl peroxide.

Embodiment 41. The adhesive tape of any one of embodiments 21, and 22, wherein the adhesive tape comprises a Tape Electrolyte Exposure Peel Force (TEEPF) of at least about 0.5 N/cm.

Embodiment 42. The adhesive tape of any one of embodiments 21, and 22, wherein the adhesive tape comprises a Tape Electrolyte Exposure Peel Force (TEEPF) of not greater than about 15 N/cm.

Embodiment 43. The adhesive tape of any one of embodiments 21, and 22, wherein the adhesive tape comprises a Tape Electrolyte Exposure Peel Force Retention (TEEPF-R) of at least about 0.4, where the TEEPF-R is equal to Tape Electrolyte Exposure Peel Force (TEEPF) of the pressure sensitive adhesive divided by the Tape Original Peel Force (TOPF) of the pressure sensitive adhesive.

Embodiment 44. The adhesive tape of any one of embodiments 21, and 22, wherein the adhesive tape comprises a Tape Electrolyte Exposure Peel Force Retention (TEEPF-R) of not greater than about 1.0, where the TEEPF-R is equal to the Tape Electrolyte Exposure Peel Force (TEEPF) of the pressure sensitive adhesive divided by the Tape Original Peel Force (TOPF) of the pressure sensitive adhesive.

Embodiment 45. The adhesive tape of any one of embodiments 21, and 22, wherein the pressure sensitive adhesive comprises a polyisobutylene based material content of at least about 40.00 wt. % for a total weight of the pressure sensitive adhesive.

Embodiment 46. The adhesive tape of any one of embodiments 21, and 22, wherein the pressure sensitive adhesive comprises a polyisobutylene based material content of not greater than about 99.75 wt. % for a total weight of the pressure sensitive adhesive.

Embodiment 47. The adhesive tape of any one of embodiments 21, and 22, wherein the pressure sensitive adhesive comprises a peroxide based additive content of at least about 0.25 wt. % for a total weight of the pressure sensitive adhesive.

Embodiment 48. The adhesive tape of any one of embodiments 21, and 22, wherein the pressure sensitive adhesive comprises a peroxide based additive content of not greater than about 5.0 wt. % for a total weight of the pressure sensitive adhesive.

Embodiment 49. The adhesive tape of any one of embodiments 21, and 22, wherein the pressure sensitive adhesive comprises a tackifying resin content of at least about 0.1 wt. % a total weight of the pressure sensitive adhesive.

Embodiment 50. The adhesive tape of any one of embodiments 21, and 22, wherein the pressure sensitive adhesive comprises a tackifying resin content of not greater than about 30.0 wt. % a total weight of the pressure sensitive adhesive.

Embodiment 51. The adhesive tape of any one of embodiments 21, and 22, wherein the polyisobutylene based material comprises a polyisobutylene content of at least about 40 wt. % for a total weight of the polyisobutylene based material.

Embodiment 52. The adhesive tape of any one of embodiments 21, and 22, wherein the polyisobutylene based material comprises a polyisobutylene content of not greater than about 99.75 wt. % for a total weight of the polyisobutylene based material.

Embodiment 53. The adhesive tape of any one of embodiments 21, and 22, wherein the polyisobutylene based material consists of polyisobutylene.

Embodiment 54. The adhesive tape of any one of embodiments 21, and 22, wherein the peroxide based additive comprises a peroxide content of at least about 5.0 wt. % for a total weight of the peroxide based additive.

Embodiment 55. The adhesive tape of any one of embodiments 21, and 22, wherein the peroxide based additive comprises a peroxide content of not greater than about 30.0 wt. % for a total weight of the peroxide based additive.

Embodiment 56. The adhesive tape of any one of embodiments 21, and 22, wherein the peroxide based additive consists of peroxide.

Embodiment 57. The adhesive tape of any one of embodiments 21, and 22, wherein the peroxide based additive comprises a benzyl peroxide.

Embodiment 58. The adhesive tape of any one of embodiments 21, and 22, wherein the peroxide based additive consists of a benzyl peroxide.

Embodiment 59. The adhesive tape of any one of embodiments 21, and 22, wherein the backing material comprises a polymer film, a paper fabric, a woven fabric, a non-woven fabric, or a metal foil.

Embodiment 60. The adhesive tape of embodiment 59, wherein the backing material comprises a polymer film.

Embodiment 61. The adhesive tape of embodiment 60, wherein the polymer film comprises polyolefin, PET, PI, PEN, or any combination thereof.

Embodiment 62. The adhesive tape of embodiment 60, wherein the backing material comprises PET.

Embodiment 63. The adhesive tape of embodiment 60, wherein the backing material comprises PI.

Embodiment 64. The adhesive tape of embodiment 59, wherein the backing material comprises a metal foil.

Embodiment 65. The adhesive tape of embodiment 59, wherein the metal foil comprises copper, aluminum, steel, or any combination thereof.

Embodiment 66. The adhesive tape of any one of embodiments 21, and 22, wherein the backing material is a backing material layer.

Embodiment 67. The adhesive tape of embodiment 66, wherein the backing material layer has a thickness of at least about 5 microns.

Embodiment 68. The adhesive tape of embodiment 66, wherein the backing material layer has a thickness of not greater than about 500 microns.

Embodiment 69. The adhesive tape of any one of embodiments 21, and 22, wherein the pressure sensitive adhesive is applied as a pressure sensitive adhesive layer.

Embodiment 70. The adhesive tape of embodiment 69, wherein the pressure sensitive adhesive layer has a thickness of at least about 4 microns.

Embodiment 71. The adhesive tape of embodiment 69, wherein the pressure sensitive adhesive layer has a thickness of not greater than about 200 microns.

Embodiment 72. The adhesive tape of any one of embodiments 21, and 22, wherein the adhesive tape has a thickness of at least about 10 microns.

Embodiment 73. A method of forming a pressure sensitive adhesive, wherein the method comprises: providing a precursor mixture of a polyisobutylene based material, and a peroxide based additive, and curing the precursor mixture to form a pressure sensitive adhesive, wherein the pressure sensitive adhesive comprises an Adhesive Electrolyte Exposure Peel Force (AEEPF) of at least about 0.5 N/cm.

Embodiment 74. A method of forming a pressure sensitive adhesive, wherein the method comprises: providing a precursor mixture of a polyisobutylene based material, and a peroxide based additive, and curing the precursor mixture to form a pressure sensitive adhesive, wherein the pressure sensitive adhesive comprises an Adhesive Electrolyte Exposure Peel Force Retention (AEEPF-R) of at least about 0.4, where the AEEPF is equal to Adhesive Electrolyte Exposure Peel Force (AEEPF) of the pressure sensitive adhesive divided by the Adhesive Original Peel Force (AOPF) of the pressure sensitive adhesive.

Embodiment 75. A method of forming an adhesive tape, wherein the method comprises: providing a precursor mixture of a polyisobutylene based material, and a peroxide based additive, applying the precursor mixture on a first side of a backing material, and curing the precursor mixture to form a pressure sensitive adhesive on the first side of the backing material, wherein the pressure sensitive adhesive comprises: a polyisobutylene based material, and a peroxide based additive, wherein the adhesive tape comprises a Tape Electrolyte Exposure Peel Force (TEEPF) of at least about 0.5 N/cm.

Embodiment 76. A method of forming an adhesive tape, wherein the method comprises: providing a precursor mixture of a polyisobutylene based material, and a peroxide based additive, applying the precursor mixture on a first side of a backing material, and curing the precursor mixture to form a pressure sensitive adhesive on the first side of the backing material, wherein the pressure sensitive adhesive comprises: a polyisobutylene based material, and a peroxide based additive, wherein the adhesive tape comprises a Tape Electrolyte Exposure Peel Force Retention (TEEPF-R) of at least about 0.4, where the TEEPF-R is equal to Tape Electrolyte Exposure Peel Force (TEEPF) of the adhesive tape divided by the Tape Original Peel Force (TOPF) of the adhesive tape.

Embodiment 77. The adhesive tape or method of any one of embodiments 21, 22, 75, and 76, wherein the adhesive tape has a thickness of not greater than about 500 microns.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A pressure sensitive adhesive comprising:
a polyisobutylene based material, and
a peroxide based additive,
wherein the pressure sensitive adhesive comprises an Adhesive Electrolyte Exposure Peel Force (AEEPF) of at least about 0.5 N/cm.

2. The pressure sensitive adhesive of claim 1, wherein the pressure sensitive adhesive comprises an Adhesive Electrolyte Exposure Peel Force (AEEPF) of at least about 0.5 N/cm.

3. The pressure sensitive adhesive of claim 1, wherein the pressure sensitive adhesive comprises an Adhesive Electrolyte Exposure Peel Force (AEEPF) of not greater than about 15 N/cm.

4. The pressure sensitive adhesive of claim 1, wherein the pressure sensitive adhesive comprises an Adhesive Electrolyte Exposure Peel Force Retention (AEEPF-R) of at least about 0.4, where the AEEPF is equal to Adhesive Electrolyte Exposure Peel Force (AEEPF) of the pressure sensitive adhesive divided by the Adhesive Original Peel Force (AOPF) of the pressure sensitive adhesive.

5. The pressure sensitive adhesive of claim 1, wherein the pressure sensitive adhesive comprises an Adhesive Electrolyte Exposure Peel Force Retention (AEEPF-R) of not greater than about 1.0, where the AEEPF is equal to Adhesive Electrolyte Exposure Peel Force (AEEPF) of the pressure sensitive adhesive divided by the Adhesive Original Peel Force (AOPF) of the pressure sensitive adhesive.

6. The pressure sensitive adhesive of claim 1, wherein the pressure sensitive adhesive comprises a polyisobutylene based material content of at least about 40.00 wt. % and not greater than about 99.75 wt. % for a total weight of the pressure sensitive adhesive.

7. The pressure sensitive adhesive of claim 1, wherein the pressure sensitive adhesive comprises a peroxide based additive content of at least about 0.25 wt. % and not greater than about 5.0 wt. % for a total weight of the pressure sensitive adhesive.

8. The pressure sensitive adhesive of claim 1, wherein the pressure sensitive adhesive comprises a tackifying resin content of at least about 0.1 wt. % and not greater than about 30.0 wt. % for a total weight of the pressure sensitive adhesive.

9. The pressure sensitive adhesive of claim 1, wherein the polyisobutylene based material comprises a polyisobutylene content of at least about 40 wt. % and not greater than about 99.75 wt. % for a total weight of the polyisobutylene based material.

10. The pressure sensitive adhesive of claim 1, wherein the polyisobutylene based material consists of polyisobutylene.

11. The pressure sensitive adhesive of claim 1, wherein the peroxide based additive comprises a peroxide content of at least about 5.0 wt. % and not greater than about 30.0 wt. % for a total weight of the peroxide based additive.

12. The pressure sensitive adhesive of claim 1, wherein the peroxide based additive consists of peroxide.

13. The pressure sensitive adhesive of claim 1, wherein the peroxide based additive comprises a benzyl peroxide.

14. A pressure sensitive adhesive comprising:
a polyisobutylene based material, and
a peroxide based additive,
wherein the pressure sensitive adhesive comprises an Adhesive Electrolyte Exposure Peel Force Retention (AEEPF-R) of at least about 0.4, where the AEEPF-R is equal to Adhesive Electrolyte Exposure Peel Force (AEEPF) of the pressure sensitive adhesive divided by the Adhesive Original Peel Force (AOPF) of the pressure sensitive adhesive.

15. The pressure sensitive adhesive of claim 14, the pressure sensitive adhesive comprises an Adhesive Electrolyte Exposure Peel Force (AEEPF) of at least about 0.5 N/cm.

16. The pressure sensitive adhesive of claim 14, wherein the pressure sensitive adhesive comprises an Adhesive Electrolyte Exposure Peel Force (AEEPF) of not greater than about 15 N/cm.

17. The pressure sensitive adhesive of claim 14, wherein the pressure sensitive adhesive comprises an Adhesive Electrolyte Exposure Peel Force Retention (AEEPF-R) of at least about 0.4, where the AEEPF is equal to Adhesive Electrolyte Exposure Peel Force (AEEPF) of the pressure sensitive adhesive divided by the Adhesive Original Peel Force (AOPF) of the pressure sensitive adhesive.

18. The pressure sensitive adhesive of claim 14, wherein the pressure sensitive adhesive comprises an Adhesive Electrolyte Exposure Peel Force Retention (AEEPF-R) of not greater than about 1.0, where the AEEPF is equal to Adhesive Electrolyte Exposure Peel Force (AEEPF) of the pressure sensitive adhesive divided by the Adhesive Original Peel Force (AOPF) of the pressure sensitive adhesive.

19. The pressure sensitive adhesive of claim 14, wherein the pressure sensitive adhesive comprises a polyisobutylene based material content of at least about 40.00 wt. % and not greater than about 99.75 wt. % for a total weight of the pressure sensitive adhesive.

20. An adhesive tape comprising:
a backing material, and
a pressure sensitive adhesive applied over a first surface of the backing material,
wherein the pressure sensitive adhesive comprises:
a polyisobutylene based material, and
a peroxide based additive,
wherein the adhesive tape comprises a Tape Electrolyte Exposure Peel Force (TEEPF) of at least about 0.5 N/cm.
